(19) United States
(12) Patent Application Publication
(10) Pub. No.: US 2026/0146838 A1
(43) Pub. Date: May 28, 2026

(54) METHOD FOR MEASURING THE GEOMETRY OF A HELICAL TOOTHING

(71) Applicant: Liebherr-Verzahntechnik GmbH, Kempten (DE)

(72) Inventors: Hansjoerg GEISER, Kempten (DE); Daniel FUNKE, Kempten (DE)

(21) Appl. No.: 19/400,897

(22) Filed: Nov. 25, 2025

(30) Foreign Application Priority Data
Nov. 28, 2024 (DE) 10 2024 135 196.9

(51) Int. Cl. G01B 5/20; G01B 5/008

(52) U.S. Cl. CPC G01B 5/202; G01B 5/008

(57) ABSTRACT

The present disclosure relates to a method for measuring the geometry of a helical toothing, in which a sensor is guided along at least one measuring path over a tooth flank of the toothing in order to measure the geometry of the tooth flank along the measuring path at a plurality of points, wherein the measuring path extends, at least in a partial region, obliquely over the tooth flank such that it sweeps an engagement region on the tooth flank over at least 50% of its extent in the profile direction and in the flank-line direction.

### CROSS REFERENCE TO RELATED APPLICATIONS

The present application claims priority to German Patent Application No. 102024 135 196.9 filed on November 28, 2024. The entire contents of the above-listed application are hereby incorporated by reference for all purposes.

### TECHNICAL FIELD

Conventional methods for measuring tooth flanks record measured values along flank lines and/or profile lines, as shown in FIG. 1A and FIG. 1B.

### BACKGROUND

A flank line (FIG. 1A) is measured along a line from one end face of the gearwheel to the other end face. This line is taken at a defined diameter of the gearwheel. A profile (FIG. 1B) is measured along a line from the tooth root to the tooth tip. This line is taken at a defined position of the tooth width.

### SUMMARY

As is apparent from FIG. 1A and FIG. 1B, a plurality of profile and/or flank lines can also be measured. The combination of the measuring points along these lines yields the topography of the gearwheel, which permits an areal evaluation.

Evaluation programs are known, such as the “Abweichungsanalyse 6.1D” [Abweichungsanalyse 6.1D /8 – Hochschule für angewandte Wissenschaften Hamburg, Department Maschinenbau + Produktion, Institut für Produktionstechnik, www.ggravel.de, 2024], which determines a spectrum of waviness amplitudes by performing a waviness analysis by means of a best-fit sine function over the flank lines of all teeth.

The result can be used in comparison with results from gear test benches and also for assessing the manufacturing process.

It is an object of the present disclosure to provide improved methods for measuring and analyzing the geometry of toothings.

This object is achieved by the methods described herein.

In a first aspect, the present disclosure provides a method for measuring the geometry of a helical toothing, in which a sensor is guided along at least one measuring path over a tooth flank of the toothing in order to measure the geometry of the tooth flank along the measuring path at a plurality of points. According to the disclosure, the measuring path in this case extends at least in a partial region obliquely over the tooth flank, such that it sweeps over an engagement region on the tooth flank over at least 50% of its extent in the profile direction and in the flank-line direction.

The inventors of the present disclosure have recognized that the consideration of profile lines and/or flank lines, as carried out in the prior art, leads to reliable results only for spur toothings, since in a spur toothing the measured flank lines correspond to the lines of contact in the gear meshing with the mating gearwheel and the profile lines correspond to the contact path from contact-line point to contact-line point.

In a helical toothing, by contrast, the lines of contact run obliquely over the tooth flank – they become steeper the greater the helix angle is. The inventors of the present disclosure have recognized that the difference between flank lines / profile lines and the real engagement conditions leads to ambiguity or to different possible interpretations of the results, since the real engagement conditions of the toothing with a mating gearwheel are not analyzed. As will be explained in more detail below, an analysis of the geometry of the toothing along at least one path which extends at least in a partial region obliquely over the tooth flank therefore leads, in the case of helical toothings, to significantly more informative results. Here, the measuring path runs on the tooth flank in such a way that it sweeps over an engagement region on the tooth flank over at least 50% of the extent of the engagement region in the profile direction and in the flank-line direction. This ensures that, with only a single measuring path, a sufficiently large area of the engagement region is captured.

Within the context of the present disclosure, the engagement region on the tooth flank is that region with which the helical toothing, during rolling on a mating toothing, comes into engagement with the latter, i.e. which comes into contact with the mating toothing. This region is usually specified for toothings in the data sheet. The engagement region may in this case be smaller than the tooth flank.

In order to have a sufficient number of data points available for such an analysis, in the case of the methods known from the prior art for measuring the surface, the tooth flank would have to be measured areally with a multiplicity of measuring paths. With the method according to the disclosure, however, a single measuring path is sufficient in the simplest case, and nevertheless an informative analysis can be carried out.

According to one possible embodiment of the present disclosure, it is provided that the measuring path sweeps over an engagement region on the tooth flank over at least 60% of its extent in the profile direction and/or in the flank-line direction, optionally over at least 80% of its extent in the profile direction and/or in the flank-line direction, and optionally over at least 90% of its extent in the profile direction and/or in the flank-line direction. In some examples, the measuring path may sweep over the engagement region over its entire extent in the profile direction and/or in the flank-line direction.

According to a further possible embodiment of the present disclosure, it is provided that the measuring path sweeps over the tooth flank over at least 50% of its extent in the profile direction and/or in the flank-line direction, optionally over at least 60% of its extent in the profile direction and/or in the flank-line direction, and optionally over at least 80% or 90% of its extent in the profile direction and/or in the flank-line direction. This all the more ensures that the engagement region is adequately captured, since the latter generally forms a subregion of the tooth flank.

According to a possible embodiment of the present disclosure, the helical toothing is an involute toothing.

In this case, the term tooth flank denotes the involute region of the toothing.

In the case of an involute toothing, the above percentages of the extent relate to the extent in a roll-length/width diagram. Such diagrams are shown in FIG. 3 and FIG. 4.

However, the present disclosure is also applicable to non-involute toothings. In this case, the indications likewise relate to a roll-length/width diagram, the roll length being taken as the arc length of the path of contact.

According to one possible embodiment of the present disclosure, the at least one measuring path has a first and a second partial region in which it extends obliquely over the tooth flank, a section optionally being located between the first and the second partial region in which the at least one measuring path runs at a different angle than in the first and/or second partial region. For example, the angle at which the measuring path runs in the section between the first and the second partial region may be an angle of at most 20° and optionally at most 10° to the profile direction or to the flank-line direction. Optionally, it runs in the profile direction or in the flank-line direction. In this way, the measuring path follows the typical shape of a contact path on the tooth flank and is therefore particularly suitable for analysis.

According to one possible embodiment of the present disclosure, the at least one measuring path extends from a first corner region of the engagement region on the tooth flank to a diagonally opposite corner region of the engagement region. Optionally, the corner regions in this case have an extent of at most 25% of the height and the width of the engagement region around the respective corner, optionally at most 10%. Here, height and width are again to be understood as the height in the profile direction and the width in the flank-line direction. This likewise means that the measuring path at least approximates the typical shape of a contact path on the tooth flank and is therefore particularly suitable for analysis.

According to one possible embodiment of the present disclosure, the at least one measuring path extends from a first corner of the engagement region on the tooth flank to the diagonally opposite corner of the engagement region. As a result, the measuring path corresponds to the typical shape of a contact path on the tooth flank and is therefore best suited for analysis.

The above-mentioned angles and percentages likewise relate to the extent of the measuring path in a roll-length/width diagram, which is available for involute toothings from the rolling geometry and for which, in the case of non-involute toothings, the arc length of the path of contact is used as the roll length.

According to a possible embodiment of the present disclosure, the position and/or the course of the at least one measuring path is determined as a function of the macro-geometry of the toothing and/or of a gear stage comprising the toothing and a mating toothing, for example a mating gearwheel. In this way, the measuring path can be adapted to the engagement conditions at the toothing.

For example, the position and/or the course of the at least one measuring path is determined as a function of the overlap ratio, i.e. the ratio of the toothing width b to the axial pitch px of the toothing. This ratio is decisive for the course of the contact paths on the tooth flank.

Alternatively or additionally, the position and/or the course of the at least one measuring path is determined as a function of the path of contact, the engagement region, the toothing width and/or the base helix angle. These parameters likewise influence the course of the contact paths.

Alternatively or additionally, for determining the overlap ratio and/or the measuring path, the engagement width can be used instead of the toothing width. This is particularly advantageous when the toothing is not in engagement with the mating gearwheel over its entire width.

According to a possible embodiment of the present disclosure, the position and/or the course of the at least one measuring path is determined as a function of the macro-geometry of a gear stage composed of the toothing and a mating toothing, for example a mating gearwheel, for example as a function of the engagement region on the tooth flank defined thereby.

According to a possible embodiment of the present disclosure, a theoretical contact path with a mating toothing, for example a mating gearwheel, is determined and the course of the measuring path is determined on the basis of the contact path.

For example, the measuring path is in this case determined such that it deviates from the course of the contact path only by a maximum permissible amount.

According to one possible embodiment of the present disclosure, the at least one measuring path extends along a theoretical contact path with a mating gearwheel. It is therefore possible that the course of such a contact path with a mating gearwheel is determined and that the measuring path is selected such that it runs along the theoretical contact path.

According to one possible embodiment of the present disclosure, the contact path with a mating toothing and for example with a mating gearwheel is defined by the course, during rolling on one another, of a point on the lines of contact between the toothing and the mating toothing, for example the mating gearwheel, which divides the lines of contact with respect to their length in a predetermined ratio.

In this context, a measuring path is optionally selected which corresponds to the central contact path, i.e. a contact path with a mating gearwheel which is defined by the course of the midpoint of the lines of contact or which divides the lines of contact in half in each case.

According to a further possible embodiment of the present disclosure, the measurement is carried out on a gear-measuring machine which has an input function via which the position and/or the course of the at least one measuring path and/or the number of measuring paths per tooth flank can be set.

According to a further possible embodiment of the present disclosure, the tooth flank is measured only along a single measuring path. Even this allows meaningful analyses of the tooth flank.

According to one possible embodiment of the present disclosure, the tooth flank is measured along a plurality of measuring paths which extend at least in a partial region obliquely over the tooth flank.

These are optionally measuring paths which run and/or are determined in the manner already described above for the at least one measuring path.

For example, a plurality of measuring paths are used here which in each case extend along a theoretical contact path with a mating gearwheel, the contact paths dividing the lines of contact in each case in a different ratio with respect to their length.

According to a possible embodiment of the present disclosure, all measuring paths have the same endpoints, the measurements optionally being traversed in both directions. Thus, the measurement along a first measuring path, which is traversed in a first direction, is followed immediately by the measurement along a second measuring path, which is traversed in the opposite direction.

According to a further possible embodiment of the present disclosure, a plurality of tooth flanks of the toothing are each measured along at least one measuring path which extends at least in a partial region obliquely over the tooth flank. Measuring a plurality of tooth flanks improves the analysis of the toothing.

These are optionally in each case measuring paths which run and/or are determined in the manner already described above for the at least one measuring path.

According to a further possible embodiment of the present disclosure, the plurality of tooth flanks are in each case measured only along a single measuring path.

According to a further possible embodiment of the present disclosure, the plurality of tooth flanks are in each case measured along the same measuring path. This improves the consistency of the analysis.

For example, the tooth flanks are in each case measured along a measuring path which extends along a theoretical contact path with a mating gearwheel that is defined by the course of the midpoint of the lines of contact between the toothing and the mating gearwheel.

The method according to the disclosure and the measuring paths according to the disclosure can be used for any desired configurations of the measuring method.

For example, the measurement of the tooth flank along the measuring path may be carried out either point by point or in a scanning manner, i.e. depending on the configuration, for individual discrete points along the measuring path or continuously over the entire measuring path. However, a scanning measurement may be preferred in some cases.

Optionally, a tactile sensor, for example a tactile measuring probe, can be used as the sensor. This can be used either in a probing mode for discrete points or in a scanning mode.

An optical sensor can likewise be used, for example an optical measuring probe.

In a second aspect, the present disclosure provides a method for analyzing the geometry of a helical toothing, in which, for the analysis, the geometry of the toothing is considered along at least one path which extends at least in a partial region obliquely over the tooth flank. As already explained in relation to the first aspect, an analysis along such a path yields, in the case of helical toothings, significantly more informative results, since the difference between the path under examination and the actual contact paths on the toothing is smaller than in the case of examination along a profile line or flank line.

According to one possible embodiment of the present disclosure, a waviness analysis and/or a vibration analysis of the geometry of the helical toothing is carried out within the framework of the analysis.

For example, the waviness along the path is analyzed, for example by decomposing the waviness into different frequencies, for example by a Fourier analysis, and/or by determining a spectrum of the waviness amplitudes along the path.

According to one possible embodiment of the present disclosure, the analysis is carried out along precisely one path over the tooth flank, i.e. only one path is considered per tooth flank.

According to one possible embodiment of the present disclosure, the at least one path sweeps over an engagement region on the tooth flank over at least 50% of its extent in the profile direction and in the flank-line direction.

According to one possible embodiment of the present disclosure, it is provided that the path sweeps over an engagement region on the tooth flank over at least 60% of its extent in the profile direction and/or in the flank-line direction, optionally over at least 80% of its extent in the profile direction and/or in the flank-line direction, and optionally over at least 90% of its extent in the profile direction and/or in the flank-line direction. For example, the path may sweep over the engagement region over its entire extent in the profile direction and/or in the flank-line direction.

According to a further possible embodiment of the present disclosure, it is provided that the path sweeps over the tooth flank over at least 50% of its extent in the profile direction and/or in the flank-line direction, optionally over at least 60% of its extent in the profile direction and/or in the flank-line direction, and optionally over at least 80% or 90% of its extent in the profile direction and/or in the flank-line direction. This all the more ensures that the engagement region is adequately captured, since the latter generally forms a subregion of the tooth flank.

According to one possible embodiment of the present disclosure, the at least one path has a first and a second partial region in which it extends obliquely over the tooth flank, a section optionally being located between the first and the second partial region in which the at least one path runs at a different angle than in the first and/or second partial region. Alternatively or additionally, in this region the at least one path may run at an angle of at most 20° and optionally at most 10° to the profile direction or to the flank-line direction, optionally in the profile direction or in the flank-line direction.

According to one possible embodiment of the present disclosure, the at least one path extends from a first corner region of the engagement region on the tooth flank to a diagonally opposite corner region of the engagement region. Optionally, the corner regions in this case have an extent of at most 25% of the height and the width of the engagement region around the respective corner, optionally at most 10%. Here again, height and width are to be understood as the height in the profile direction and the width in the flank-line direction. This likewise means that the path at least approximates the typical shape of a contact path on the tooth flank and is therefore particularly suitable for analysis.

According to one possible embodiment of the present disclosure, the at least one path extends from a first corner of an engagement region on the tooth flank to the diagonally opposite corner of the engagement region.

As already described above for the measuring paths, these configurations of the path correspond to the general shape of the contact paths of helical toothings, so that more relevant results are obtained along these paths.

According to one possible embodiment of the present disclosure, in the context of the second aspect as well the helical toothing is an involute toothing.

In this case, the term tooth flank denotes the involute region of the toothing.

In the case of an involute toothing, the above-mentioned percentages and angular indications of the extent relate to the extent or course of the path in a roll-length/width diagram. Such diagrams are shown in FIG. 3 and FIG. 4.

However, the present disclosure is also applicable according to the second aspect to non-involute toothings. In this case, the indications likewise relate to a roll-length/width diagram, the roll length being taken as the arc length of the path of contact.

According to one possible embodiment of the present disclosure, the position and/or the course of the at least one measuring path is determined as a function of the macro-geometry of the toothing and/or of a gear stage composed of the toothing and a mating gearwheel, for example as a function of the overlap ratio.

Alternatively or additionally, the position and/or the course of the at least one path is determined as a function of the path of contact, the toothing width and/or the base helix angle.

According to one possible embodiment of the present disclosure, the at least one path extends along a theoretical contact path with a mating gearwheel.

The advantages of this have already been explained above with regard to the determination of the measuring paths.

According to one possible embodiment of the present disclosure, the contact path selected as the path for the analysis is defined by the midpoints of the lines of contact between the toothing and the mating gearwheel.

According to a further possible embodiment, the analysis is carried out along a plurality of paths which extend obliquely over the tooth flank. These paths optionally run and/or are determined in the manner described above.

Furthermore, the one or more paths for the analysis are optionally determined and/or run in the way already described above for the measuring paths.

According to one possible embodiment of the present disclosure, for the analysis the geometry of the toothing is measured and the geometry of the toothing determined by the measurement is analyzed.

The method according to the second aspect is initially independent of the method according to the first aspect. For example, the analysis according to the second aspect could also be carried out on the basis of measurement data determined according to a method of the prior art. In this case, however, it is necessary to measure the tooth flank at a plurality of profile lines and/or flank lines.

The analysis of the geometry of the toothing is therefore optionally carried out on the basis of measurement data which have been determined by a method according to the disclosure according to the first aspect.

According to one possible embodiment of the present disclosure, in this case, for the analysis, the geometry of the toothing is considered along at least one path along which the toothing has been measured. For example, the analysis is carried out along a measuring path along which the toothing has been measured by a method according to the first aspect, as described above.

According to one possible embodiment of the present disclosure, the geometry of a plurality of tooth flanks along a path over the respective tooth flank is superposed for the analysis in accordance with the pitch of the toothing. The same path is optionally used in each case.

For example, a plurality of tooth flanks of the toothing are measured along at least one measuring path and the geometry of the tooth flanks measured along the respective measuring path is superposed for the analysis in accordance with the pitch of the toothing. In particular, measuring paths as described for the first aspect are used here.

Optionally, only a single measuring path per tooth flank is considered for the superposition and analysis.

According to one possible embodiment of the present disclosure, for the analysis of a gear stage both gears are measured and/or analyzed according to the disclosure, for example along a central contact path.

According to one possible embodiment of the present disclosure, during the manufacture of gear stages the two gears are measured and/or analyzed according to the disclosure, defective gears and/or gear stages being replaced and/or sorted out. For example, an inspection may be carried out for all gear stages produced.

In all aspects of the present disclosure described so far, the helical toothing is optionally arranged on a gearwheel, for example a gearwheel having a cylindrical or conical basic body. The mating gearwheel with which the contact paths are determined is likewise optionally a gearwheel, for example a gearwheel having a cylindrical or conical basic body.

The present disclosure further comprises a gear-measuring machine having a workpiece holder and a sensor by means of which the geometry of at least one tooth flank of a toothing of a workpiece received in the workpiece holder can be measured, the gear-measuring machine having one or more movement axes by means of which the sensor can be guided along at least one measuring path over a tooth flank of the toothing in order to measure the geometry of the tooth flank along the measuring path at a plurality of points, the gear-measuring machine having a controller which is configured to carry out a method as described above with regard to the first and/or second aspect.

For example, the controller is programmed to carry out a method as described above with regard to the first and/or second aspect.

The gear-measuring machine may also be a gear-measuring machine integrated in a gear machining machine, for example by arranging a sensor on a machining head of the gear machining machine, by means of which a workpiece machined or to be machined in the gear machining machine can be measured. However, the gear-measuring machine may also be a stand-alone gear-measuring machine.

The present disclosure further comprises a computer program comprising instructions which, when the program is executed by the controller of a gear-measuring machine and/or by a computer, cause it to perform a method as described above with regard to the first and/or second aspect.

The computer program may for example run on a controller of a gear-measuring machine as described above, for example for carrying out a method according to the first aspect.

However, a method according to the second aspect can also be carried out by a computer program which runs on a computer.

The controller and/or the computer optionally comprise a microcontroller and a non-volatile memory on which the computer program is stored. The controller is optionally connected to actuators of the gear-measuring machine and controls them in order to move the sensor along the measuring path, and/or is connected to the sensor in order to detect and/or evaluate the signals of the sensor.

The present disclosure will now be explained in more detail with reference to exemplary embodiments and drawings.

### BRIEF DESCRIPTION OF THE FIGURES

In the drawings:

FIG. 1A and FIG. 1B are each diagrams showing measuring paths according to the prior art which extend along flank lines and profile lines respectively.

FIG. 2A and FIG. 2B are each diagrams showing the course of the lines of contact and contact paths with a mating gearwheel on a helical toothing for the case of an overlap ratio εβ<1.0 and for the case of an overlap ratio εβ>1.0 respectively.

FIG. 3A is a first diagram showing the course of a plurality of measuring paths or paths on a tooth flank in an exemplary embodiment of a method according to the present disclosure for the case of an overlap ratio εβ>1.0.

FIG. 3B is a second diagram showing the course of a plurality of alternative measuring paths or paths on a tooth flank in an exemplary embodiment of a method according to the present disclosure for the case of an overlap ratio εβ>1.0.

FIG. 4 shows three diagrams, each showing the course of a central measuring path or path on a plurality of tooth flanks in an exemplary embodiment of a method according to the present disclosure in which a plurality of tooth flanks are measured, for the case of an overlap ratio εβ<1.0.

FIG. 5 shows three diagrams each showing the deviations of the geometry of the tooth flank from a nominal geometry along the measuring paths or paths shown in FIG. 4.

FIG. 6 shows a diagram in which the deviations shown in FIG. 5 on the individual tooth flanks are shown superposed taking into account the pitch.

FIG. 7 shows two diagrams, the first of which shows the determination of a common deviation profile by forming maximum values in the superposition shown in FIG. 6 and the second of which shows the deviation profile resulting therefrom.

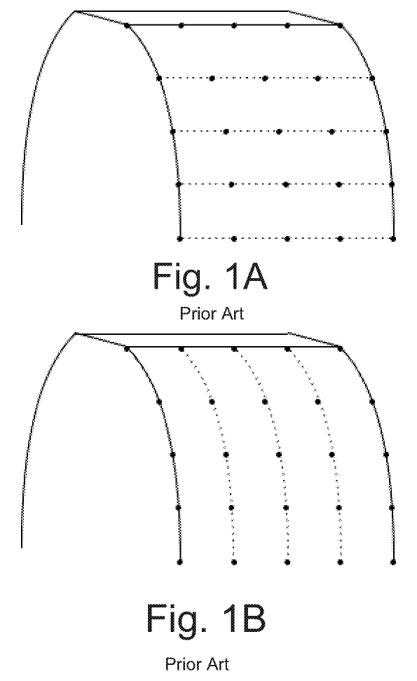

### DETAILED DESCRIPTION

As already described in the introduction, in a spur toothing the measured flank lines correspond to the lines of contact in the gear meshing with a mating toothing and for example with the mating gearwheel. The profile lines correspond to the contact path from contact-line point to contact-line point.

In a helical toothing, by contrast, the lines of contact run obliquely over the tooth flank – they become steeper the greater the helix angle is.

The difference between flank lines / profile lines and the real engagement conditions in this case leads, in an analysis of the geometry of the toothing along the flank lines and/or profile lines, to ambiguity or different possible interpretations of the results, since the real engagement conditions of gearwheel / gearwheel are not analyzed.

The core idea of the present disclosure is therefore to improve the interpretability of the results by analyzing and/or measuring along paths which extend obliquely over the tooth flank and thus at least come significantly closer to an actual contact path than flank lines / profile lines. The course of the path is selected such that it sweeps over a sufficiently large part of the engagement region with the mating toothing, both in the profile direction and in the flank-line direction. The paths optionally extend along the actual contact path in the engagement of the toothing with the toothing on a mating gearwheel, i.e. in the engagement of two gears, or at least approximate such a contact path.

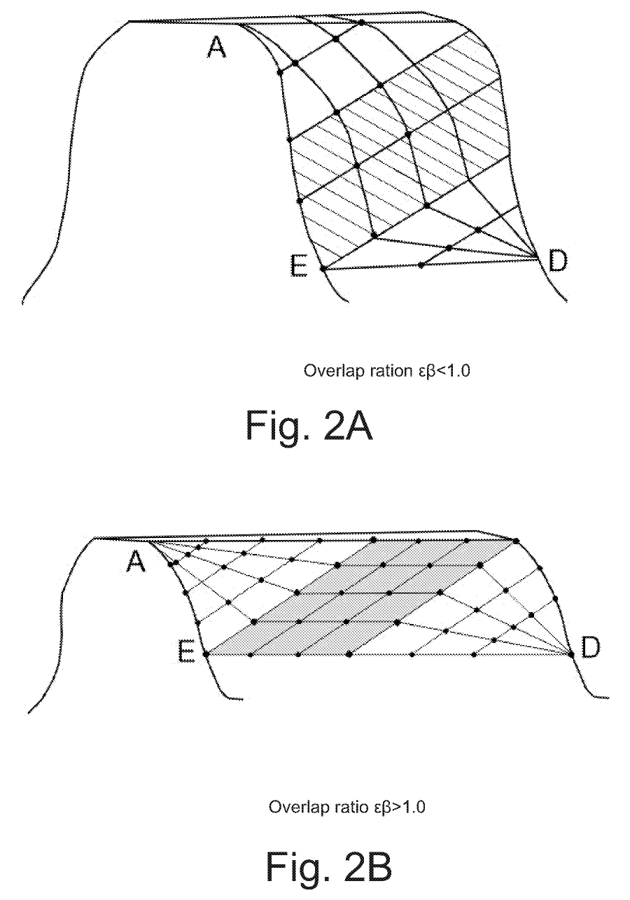

The overlap ratio εβ = b/px represents the ratio of the toothing width b to the axial pitch px. If this ratio is less than 1, the oblique lines of contact, as shown in FIG. 2A, become longer from the beginning of engagement A until they run over the entire toothing width. The line of contact then rolls over the profile as far as point E and then becomes shorter again towards the end of engagement D.

If the overlap ratio, as shown in FIG. 2B, is greater than 1, the oblique lines of contact become longer from the beginning of engagement A until they run over the entire profile height, and then, in engagement, shift over the toothing width and finally become shorter again over the profile on the other side towards the end of engagement D.

The contact paths are defined here as those paths over the flank which divide the lines of contact in terms of their length in a fixed ratio. For example, the central contact path is formed by the midpoints of the lines of contact. FIG. 2A and FIG. 2B each show the central contact path and contact paths which run at 25% and 75% respectively of the length of the lines of contact.

As can be seen from FIG. 2A and FIG. 2B, irrespective of the overlap ratio the contact paths run from the beginning of engagement A located in an upper corner of the tooth flank to the end of engagement D lying in the diagonally opposite lower corner of the tooth flank. Furthermore, in the case of an overlap ratio εβ not equal to 1, the contact paths each have a first and a second region in which they run, starting from the corners A and D respectively, obliquely over the tooth flank. Located between these two regions is a third region in which, in the case of an overlap ratio εβ<1.0, the contact paths run along a profile line and, in the case of an overlap ratio εβ>1.0, run along a flank line.

The profile overlap ratio εα = gα/pe represents the ratio of the path of contact gα to the base pitch pe. A profile overlap ratio εα = 1 means that a new line of contact (point A) comes into engagement as soon as the other line of contact has just reached the foot of the profile (point E) and then runs, via the overlap ratio, over the toothing width as far as the end of engagement (point D).

In a toothing with εα = 1 and εβ = 1, the line of contact becomes longer from the beginning of engagement at point A until it reaches its maximum length at point E and then becomes shorter again towards the end of engagement D: in this case there is no section in the contact paths which would run parallel to the flank line or to the profile. The contact paths therefore run, in this case, obliquely over the flank over their entire extent.

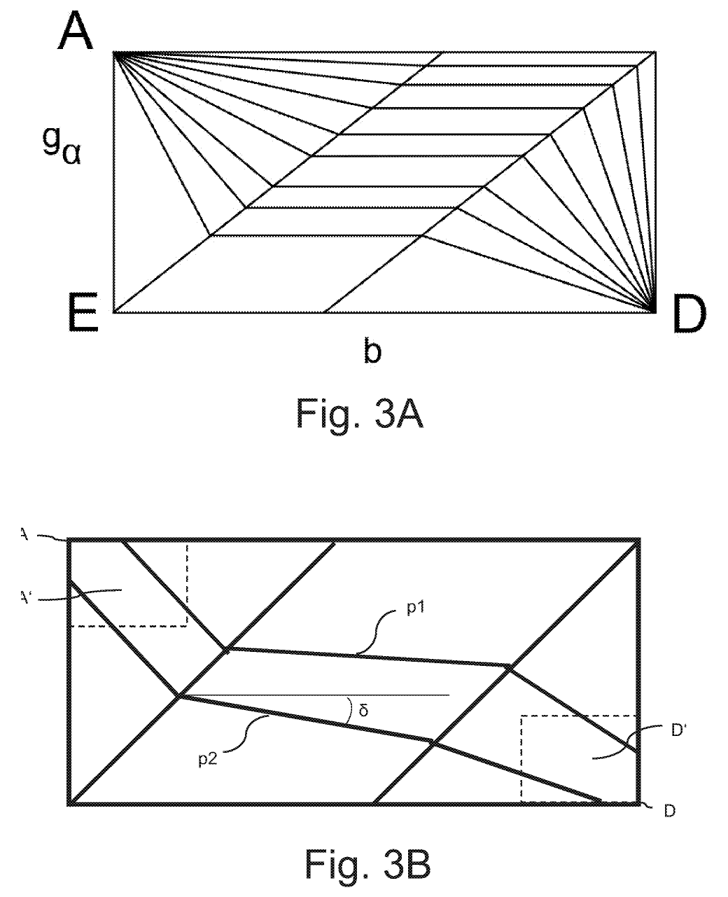

As shown in FIG. 3A, the path of contact gα and the toothing width b span the field of engagement in which the lines of contact run at the base helix angle βb relative to the toothing width. These quantities therefore also determine the course of the contact lines on the tooth flank.

According to one embodiment of the present disclosure, those paths along which the geometry of the toothing is analyzed and/or measured are therefore selected such that they correspond to the contact paths or at least have the basic form of the contact paths. The paths are therefore optionally determined as a function of the above-mentioned quantities.

FIG. 3A shows in this respect the course of 9 paths which are used for analysis and/or measurement and which correspond to the contact paths of 9 contact points per line of contact in a toothing with an overlap ratio εβ>1.0. In this case, the lines of contact are divided by way of example into 9 sections. The midpoints of each section are connected over the engagement movement from A via E to D to form the respective contact paths.

The paths shown in FIG. 3A run from a corner A of the engagement region to the diagonally opposite corner D. Furthermore, they have first and second sections in which they extend, starting from the corners A and D respectively, obliquely over the tooth flank. Located between these is a region in which the paths extend in the flank-line direction.

FIG. 3B shows alternative paths p1 and p2, which could likewise be used as measuring paths or as paths for analysis and which merely approximate the contact paths.

The paths p1 and p2 in this case run from a corner region A' to a diagonally opposite corner region D', without necessarily reaching the corners A and D.

Furthermore, here too, two regions starting from the corner regions are provided in which the paths run obliquely. In the region lying between them, the paths likewise run obliquely but with a different angle than in the first or second region. For example, in the central region the course of the paths deviates from the flank-line direction by an angle δ of at most 20°.

Although the paths p1 and p2 no longer sweep the engagement region, which extends between the points A and D, over its entire extent in the profile direction (the vertical direction in the diagram) and the flank-line direction (the horizontal direction in the diagram), the fraction of the extent in the profile direction and in the flank-line direction that is covered is still sufficiently large to enable a relevant analysis. For example, this fraction is greater than 50% of the respective extent but is optionally even greater.

In the case of an overlap ratio εβ<1.0, the same applies, except that the central region would deviate by at most 20° from the profile direction, since it is intended to approximate the profile direction.

The paths according to the disclosure now contain exactly that topology information which can be used by more sophisticated calculation programs, such as the Dynamic Tooth Forces program (DZP), for assessing the NVH behavior of the gearwheel.

In this connection, the same contact-path topology is also required for the mating gearwheel in order to be able to make an appropriate statement for the gear stage.

If, however, the aim is merely to evaluate deviations of a single gearwheel, the mating gearwheel can be assumed to be free of deviations.

However, the basic data of the gear stage specify the path of contact gα and the width of the field of engagement.

The number of line-of-contact sections and their exact location should be freely specifiable in order to be able to provide the corresponding data also for other programs such as, for example, Rikor.

Since waviness along these contact paths corresponds to the direct excitation in the gearbox, a higher correlation with the results of the end-of-line test bench can be expected.

At present, modern calculation programs are supplied with classical topology data and then internally determine the values of the contact-path topology.

However, it is possible to derive a profile-line topology / flank-line topology from a contact-path topology (for example by surface interpolation), such that the values of the contact-path topology determined back from this in turn correspond to the original topology (apart from minor deviations due to the interpolation algorithm).

An adaptation of the number of contact paths and/or their location may be necessary depending on the analysis program used. Corresponding input options are to be provided on the measuring machine.

The information obtained can, however, be used not only for advanced calculation programs.

Depending on the required accuracy and time budget, the number of contact-path measuring lines in the topology can be adapted (for example in the range 9, 5, 3 or 1). The time required, which is reduced compared with conventional topography measurements, may make it possible to measure the contact-path topology on several or optionally on all teeth.

This also makes it possible to perform a waviness analysis, as is illustrated below.

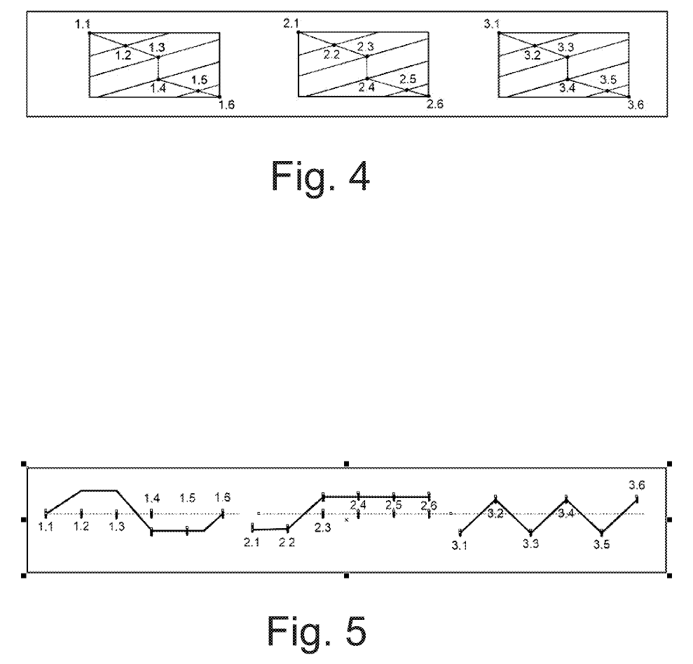

Using the central contact-path line (i.e. that contact path along the midpoints of all lines of contact of the gear meshing), this is illustrated by way of example in FIGS. 4 to 7 for 3 teeth of a toothing with a low overlap ratio.

As can be seen from FIG. 4, between the points x.3 and x.4 the contact path runs along the profile – in the other regions it runs obliquely towards the beginning of engagement A or the end of engagement D.

The deviations of the points x.1 to x.6 measured along the contact path can now be unrolled, as illustrated by way of example in FIG. 5.

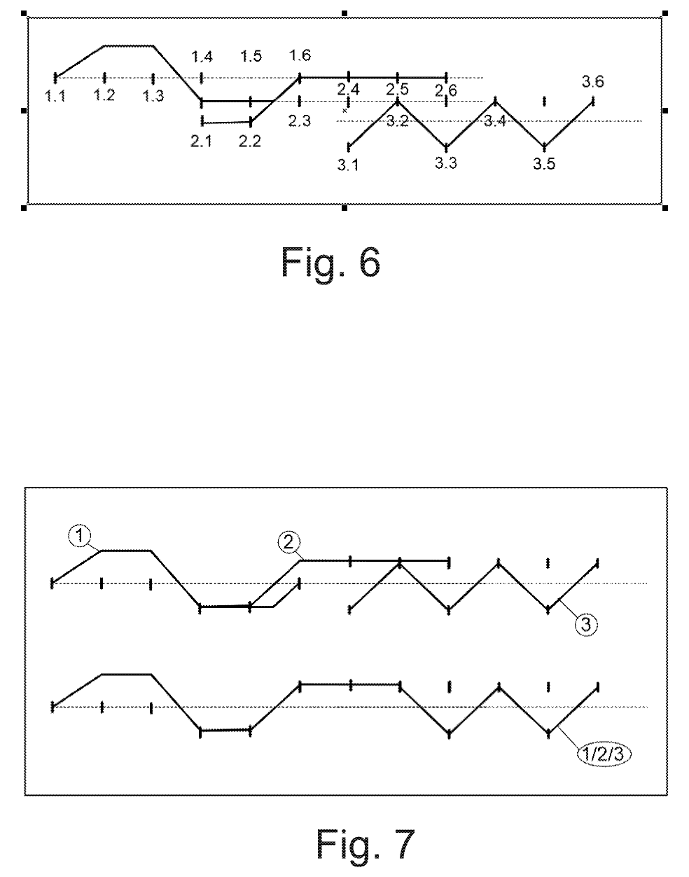

Then, the unrolled deviations on the individual tooth flanks which have been determined along the contact paths are superposed in accordance with the pitch (optionally also taking into account the individual pitch deviations from tooth to tooth), as shown in FIG. 6.

As shown in FIG. 7, the superposition is carried out in such a way that for each point the maximum value of the respective superposed deviations is selected as the value for the overall deviation. In this way, a resulting profile of the deviations of the contact paths is obtained.

The measurement and superposition are optionally carried out for all teeth of the toothing.

The overall deviation or the resulting profile of the deviations can then be analyzed, for example subjected to a waviness analysis. For example, the spectrum of the waviness is determined here by means of a best-fit sine function.

The result can be used for comparison with results from gear test benches and/or for assessing the manufacturing process.

In one possible embodiment, the deviations of the mating gearwheel are also taken into account, so that a waviness spectrum is obtained for comparison with the real tooth engagement in the EOL test bench.

In one possible embodiment, in production a test of the gears of a gear pair can be carried out in accordance with the disclosure (for example by measuring only along the central contact-path lines) in order to check the gear pair before assembly and, if necessary, to modify it or sort it out. For example, a test of all gears can be carried out, i.e. a 100% inspection can be performed.

The explanations so far describe the situation for unmodified toothings. However, the present disclosure can also be used for detecting deviations of modified toothings.

In practice, toothings are modified in particular for load-carrying capacity reasons: crowning or end relief relieves critical flank regions.

In this case, however, contact with the mating gearwheel no longer takes place over the entire extent of the theoretical lines of contact. Rather, in each engagement position without load, contact is established only at one point of the line of contact in each case. The connection of these contact points yields the real no-load contact path.

However, the deviations between such a real no-load contact path and the contact paths described above are still significantly smaller than the deviations from a flank line or profile line as used in the prior art. The contact paths described above can therefore also be used as measuring or analysis paths for modified toothings and likewise improve the information content of the data in this case.

Alternatively, in the case of modified toothings, the real no-load contact path can be determined. This can only be determined using more sophisticated calculation programs, but could, for example for questions concerning the no-load NVH behavior, serve as a specification for the measuring path.

Some possible advantages of the present disclosure will be described in more detail below.

According to the disclosure, the evaluations along the contact path correspond to the actual engagement conditions in the gearbox.

The measurement can be carried out more quickly than conventional closely spaced topology measurements while providing higher information content. Since, in the contact-path topology, as can be seen in FIG. 3, all measuring paths start at the same point A and end at point D, the measurements can be traversed in both directions.

A decisive advantage of the measured contact-path topology is that waviness / deviations are recorded directly in the direction of engagement of the gearbox – a contact path is no longer derived from individual points (classical topology), but instead a continuous line is scanned which directly contains all the information concerning the waviness acting in engagement.

1. A method for measuring a geometry of a helical toothing, in which a sensor is guided along at least one measuring path over a tooth flank of the toothing in order to measure the geometry of the tooth flank along the measuring path at a plurality of points,
wherein the measuring path extends, at least in a partial region, obliquely over the tooth flank such that it sweeps an engagement region on the tooth flank over at least 50% of its extent in a profile direction and in a flank-line direction.

2. The method according to claim 1, wherein the at least one measuring path has a first and a second partial region in which it extends obliquely over the tooth flank, and a section located between the first and the second partial region in which the at least one measuring path runs at a different angle than in the first and/or second partial region and/or at an angle of at most 20° to the profile direction or to the flank-line direction,
and/or
wherein the at least one measuring path extends from a first corner region of the engagement region on the tooth flank to a diagonally opposite corner region of the engagement region.

3. The method according to claim 1, wherein a position and/or a course of the at least one measuring path is determined as a function of the macro-geometry of the toothing and/or of a gear stage comprising the toothing and a mating toothing.

4. The method according to claim 1, wherein a theoretical contact path with a mating toothing is determined and the course of the measuring path is determined on the basis of the contact path, and/or wherein the at least one measuring path extends substantially along a theoretical contact path with a mating gearwheel, wherein the contact path with the mating gearwheel is defined by the course, during rolling on one another, of a point on the lines of contact between the toothing and the mating gearwheel which divides the lines of contact with respect to their length in a predetermined ratio.

5. The method according to claim 1, wherein the tooth flank is measured along a plurality of measuring paths which extend at least in a partial region obliquely over the tooth flank, wherein the plurality of measuring paths extend along a theoretical contact path with a mating gearwheel, wherein the contact paths each divide the lines of contact with respect to their length in a different ratio, and/or wherein all measuring paths have the same endpoints.

6. The method according to claim 1, wherein the measurement is carried out on a gear-measuring machine which has an input function by means of which the position and/or the course of the at least one measuring path and/or the number of measuring paths per tooth flank can be predefined.

7. The method according to claim 1, wherein a plurality of tooth flanks of the toothing are each measured along at least one measuring path which extends at least in a partial region obliquely over the tooth flank.

8. The method according to claim 7, wherein the plurality of tooth flanks are in each case measured along the same measuring path, which extends along a theoretical contact path with a mating gearwheel which is defined by the course of the midpoint of the lines of contact between the toothing and the mating gearwheel.

9. A method for analyzing the geometry of a helical toothing,
wherein for the analysis, the geometry of the helical toothing is considered along at least one path which extends at least in a partial region obliquely over the tooth flank.

10. The method according to claim 9, wherein the at least one path has a first and a second partial region in which it extends obliquely over the tooth flank, wherein a section is located between the first and the second partial region in which the at least one path runs at a different angle than in the first and/or second partial region and/or at an angle of at most 20° to the profile direction or to the flank-line direction, and/or wherein the at least one path extends from a first corner region of the engagement region on the tooth flank to a diagonally opposite corner region of the engagement region.

11. The method according to any one of claim 10, wherein the corner regions have an extent of at most 25% of the height and the width of the engagement region around the respective corner, wherein the at least one path extends from a first corner of the engagement region on the tooth flank to the diagonally opposite corner of the engagement region.

12. The method according to claim 9, wherein for the analysis the geometry of a plurality of tooth flanks along a path over the respective tooth flank is superposed in accordance with the pitch of the toothing, wherein a plurality of tooth flanks of the toothing is measured along at least one measuring path and the geometry of the tooth flanks measured along the respective measuring path being superposed for the analysis in accordance with the pitch of the toothing.

13. The method according to claim 9, wherein for the analysis of a gear stage both gears are measured and/or analyzed, and/or wherein during the manufacture of gear stages the two gears are measured and/or analyzed.

14. A gear-measuring machine having a workpiece holder and a sensor by means of which the geometry of at least one tooth flank of a toothing of a workpiece received in the workpiece holder can be measured, wherein the gear-measuring machine has one or more movement axes by means of which the sensor can be guided along at least one measuring path over a tooth flank of the toothing in order to measure the geometry of the tooth flank along the measuring path at a plurality of points, wherein the gear-measuring machine comprises a controller which is configured to carry out the method according to claim 1.

15. A computer program comprising instructions which, when the program is executed by a controller of a gear-measuring machine and/or by a computer, cause it to perform the method according to claim 1.

16. A computer program comprising instructions which, when the program is executed by a controller of a gear-measuring machine and/or by a computer, cause it to perform the method according to claim 9.

17. The method according to claim 1, wherein the helical toothing is a helical toothing of a gearwheel having a cylindrical macro-geometry.

18. The method according to claim 3, wherein the position and/or the course of the at least one measuring path is determined as a function of the overlap ratio, the engagement region, the path of contact, the toothing width and/or the base helix angle.

19. The method according to claim 9, wherein a waviness is analyzed along the at least one path by decomposing the waviness into different frequencies and/or by determining a spectrum of the waviness amplitudes along the path.

20. The method according to claim 9, wherein the at least one path sweeps an engagement region on the tooth flank over at least 50% of its extent in a profile direction and in a flank-line direction.
